(19) United States
(12) Patent Application Publication
(10) Pub. No.: US 2023/0079248 A1
(43) Pub. Date: Mar. 16, 2023

(54) CLEANING MEMBER, PAPER TRANSMITTING DEVICE AND OFFICE MACHINE USING THE SAME

(71) Applicant: AVISION INC., Hsinchu (TW)

(72) Inventors: Bo-Wei CHANG, Changhua County (TW); Chien-Chih CHEN, Taoyuan City (TW)

(21) Appl. No.: 17/939,232

(22) Filed: Sep. 7, 2022

(30) Foreign Application Priority Data
Sep. 10, 2021 (TW) 110133793

(51) Int. Cl. B08B 1/00; B08B 1/04; B41J 11/00; H04N 1/00; B65H 5/06; B24D 9/00

(52) U.S. Cl. CPC B08B 1/006; B08B 1/04; B41J 11/00; H04N 1/00602; H04N 1/00909; B65H 5/062; B24D 9/00; B65H 2301/531; B65H 2404/1118

(57) ABSTRACT

A paper transmitting device including a feed wheel and a cleaning member is provided. The feed wheel is rotatably disposed for driving a document to move. The cleaning member is disposed on one side of the feed wheel, and has a fabric and porous structure and a woolen friction surface, so that the cleaning member contacts the feed wheel to clean the feed wheel.

This application claims the benefit of Taiwan application Serial No. 110133793, filed Sep. 10, 2021, the disclosure of which is incorporated by reference herein in its entirety.

### TECHNICAL FIELD

The invention relates in general to a cleaning member, a paper transmitting device and an office machine using the same.

### BACKGROUND

At the office, paperwork can be processed using office automation equipment, such as a facsimile machine (fax), a scanner, a photocopier or a printer. These devices can be integrated as a multi-function printer (MFP) to save space. Based on user's needs, the multi-function printers currently available in the market are provided with an automatic document feeder (ADF) or a paper transmitting device to continuously scan several documents to save document scanning time.

However, after an automatic document feeder or a paper transmitting device is used over a period of time, the frictional force of the feed wheel will deteriorate due to an excessive amount of paper dust alighting on the surface of the feed wheel, and paper feed function will be incapacitated.

### SUMMARY

The invention is directed to a cleaning member, a paper transmitting device and an office machine using the same. The paper transmitting device is provided with a cleaning member for cleaning the feed wheel to improve paper pickup performance of the feed wheel.

According to one embodiment, a cleaning member used for cleaning a feed wheel is provided. The cleaning member has a fabric and porous structure and a friction surface.

According to another embodiment, a paper transmitting device is provided. The paper transmitting device includes a feed wheel and a cleaning member. The feed wheel is rotatably disposed for driving a document to move. The cleaning member is disposed on one side of the feed wheel, wherein the cleaning member has a fabric and porous structure and a woolen friction surface with a pressure and wear resistance, so that the cleaning member tightly and fully contacts the feed wheel to clean the feed wheel without damaging the feed wheel.

According to an alternate embodiment, an office machine is provided. The office machine includes a machinery body and a paper transmitting device, wherein the paper transmitting device is disposed in the machinery body.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is an appearance diagram of an office machine in a close state according to an embodiment of the present invention;

FIG. 2 is a schematic diagram of the office machine of FIG. 1 in an open state;

FIG. 3 is a schematic diagram of a paper transmitting device according to an embodiment of the present invention;

FIG. 4 is a three-dimensional schematic diagram and a partial enlargement of a paper transmitting device according to an embodiment of the present invention; and

FIGS. 5A and 5B respectively are schematic diagrams of a cleaning member and a partial enlargement of a friction surface thereof according to an embodiment of the present invention.

### DETAILED DESCRIPTION

Detailed descriptions of the invention are disclosed below with a number of embodiments. However, the disclosed embodiments are for explanatory and exemplary purposes only, not for limiting the scope of protection of the invention. Similar/identical designations are used to indicate similar/identical elements. Directional terms such as above, under, left, right, front or back are used in the following embodiments to indicate the directions of the accompanying drawings, not for limiting the present invention.

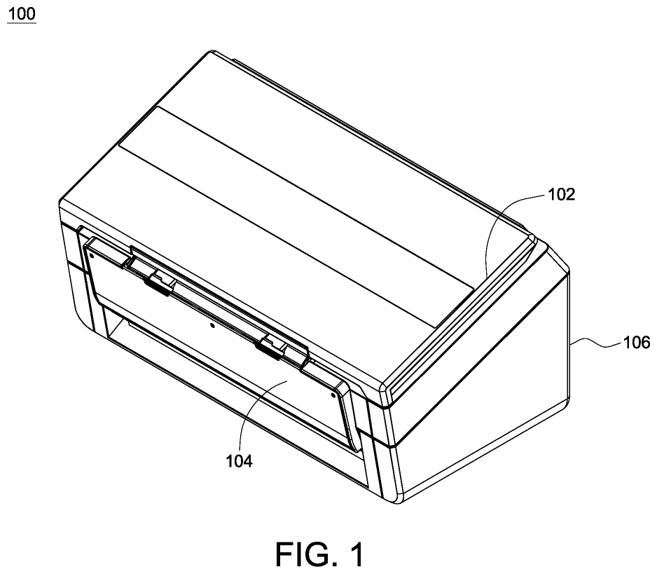

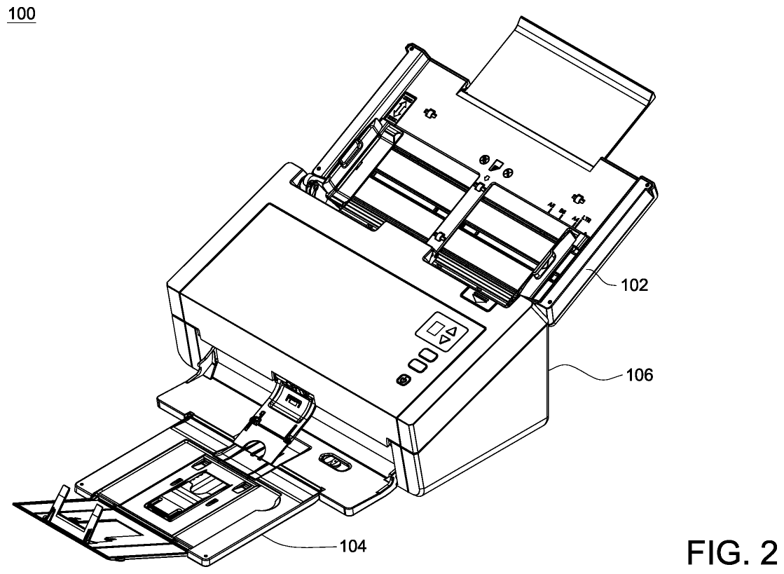

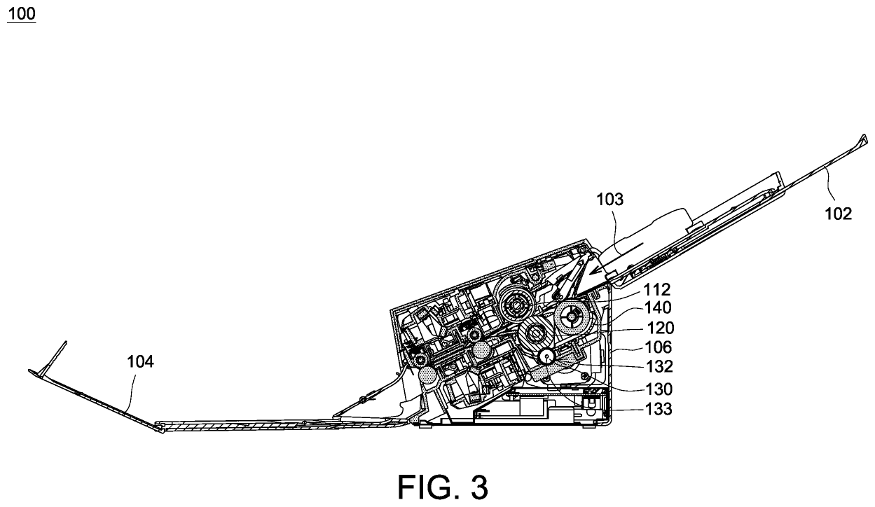

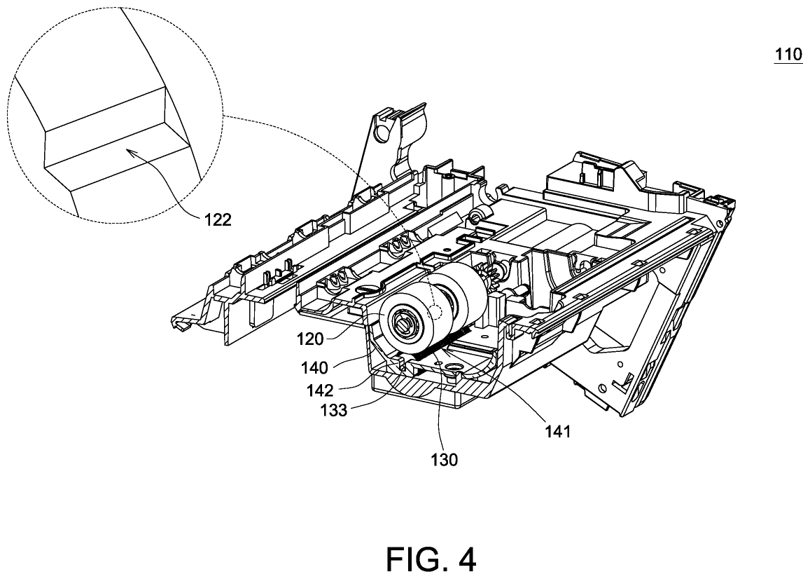

Refer to FIGS. 1, 2, 3 and 4. FIG. 1 is an appearance diagram of an office machine 100 in a close state according to an embodiment of the present invention. FIG. 2 is a schematic diagram of the office machine 100 of FIG. 1 in an open state. FIG. 3 is a schematic diagram of a paper transmitting device 110 according to an embodiment of the present invention. FIG. 4 is a three-dimensional schematic diagram and a partial enlargement of a paper transmitting device 110 according to an embodiment of the present invention.

According to an embodiment of the present invention, the paper transmitting device 110 can be used in an office machine 100, a printer, a scanner, facsimile machine, or a photocopier. The office machine 100 can be provided with an automatic document feeder. The paper transmitting device 110 includes one or more than one rotatable feed wheel 120, which contacts and rotates the document to move. However, over a period of use, when an excessive amount of paper dust alights on the surface of the feed wheel 120, the paper pickup function of the paper transmitting device 110 will be affected.

Refer to FIG. 2. The office machine 100 includes a paper feed tray 102, a paper exit tray 104 and a paper transmitting device 110 located in the machinery body 106. The paper feed tray 102 is located on one side of the office machine 100. Several documents can be on the paper feed tray 102 where the documents can be sequentially fed to the office machine 100. Refer to FIG. 3. The paper transmitting device 110 includes a driving wheel 112, a feed wheel 120 and a cleaning member 130. The machinery body 106 has a transmitting channel 103 (indicated by an arrow sign) located between the driving wheel 112 and the feed wheel 120. The driving wheel 112 is disposed on one side of the feed wheel 120 (such as the upper side). The feed wheel 120 is located between the cleaning member 130 and the driving wheel 112. The driving wheel 112 and the feed wheel 120 are used for holding and rotating the document to move.

The driving wheel 112, which can be formed by an active wheel (such as a plastic wheel), can be driven to rotate by a motor. The feed wheel 120, which can be formed by a follow-up wheel (such as a rubber wheel), is disposed under the driving wheel 112 for driving the document to move. In another embodiment (not shown), the driving wheel 112 can be located under the feed wheel 120, and the present invention does not have limitation thereto.

Besides, the cleaning member 130 is disposed on one side of the feed wheel 120, that is, the cleaning member 130 and the driving wheel 112 are located on two opposite sides of the feed wheel 120. The cleaning member 130 has a fabric and porous structure and a friction surface 132 with pressure resistance and wear resistance characteristic, so that the cleaning member 130 tightly and fully contacts the feed wheel 120 to clean the feed wheel 120. The friction surface 132 of the cleaning member 130 is pressure resistant because the cleaning member 130 has a tight structure, small pores and high density, and the cleaning member 130 manufactured according to the pressure resistant requirement can hardly be deformed. For example, the surface of the fleece felt formed using a stamping process has a high density and a space for receiving paper crumbs, so that the fleece felt can provide excellent cleaning effect. The friction surface 132 of the cleaning member 130 is wear resistant because the cleaning member 130, which is soft and refined and provided with a fabric and porous structure 134 and higher wear resistance, can easily remove tiny medium (such as paper crumbs or dust) off the surface of the feed wheel 120 without damaging or scratching the feed wheel 120. For example, the cleaning member 130 can be formed of fleece, which is soft yet tough and has an excellent fiber elasticity, can be integrally formed in one piece and is highly reductive. After the fleece felt is folded, it can quickly restore its original shape without deformation. Since the fiber structure of the fleece is tightly winded, the cleaning member 130 will not damage the feed wheel 120 when contacting the feed wheel 120 to remove paper crumbs. When the outmost layer of the fleece felt wears and comes off after repeatedly contacting the feed wheel 120, an inner layer will be exposed and used as a new surface layer of the fleece felt to continue with contact cleaning.

According to the above disclosure, the cleaning member 130 can be a woolen wheel, such as a fleece felt wheel, a horsehair wheel or a feather wheel, or can be a wheel formed of other similar woolen material, whether natural or synthetic. Also, the cleaning member 130 can be a cloth wheel, a leather wheel or a cotton wheel. As long as the cleaning member 130 is formed of a soft material and the density of the cleaning member 130 formed using a stamping process can be controlled to form a porous structure 134 for receiving paper crumbs or dust, the cleaning member 130 will be able to perform contact cleaning for the feed wheel 120.

In another embodiment, the cleaning member 130 can be a fleece polishing wheel, a nylon polishing wheel or a flat non-woven wheel. The cleaning member 130 has a fabric and porous structure and is highly wear resistant and can easily remove tiny medium (such as paper crumbs or dust) off the surface of the feed wheel 120.

Refer to FIG. 4. To avoid an excessive amount of paper crumbs alighting on the surface the feed wheel 120, at least one crumb discharge groove 122 can be disposed on the surface of the feed wheel 120. The crumb discharge groove 122 can enhance the grip force, reduce noises, discharge paper crumbs and make wearing evenly distributed. The crumb discharge groove 122 is substantially parallel to the axial direction of the feed wheel 120 and can be used as a space for receiving paper crumbs.

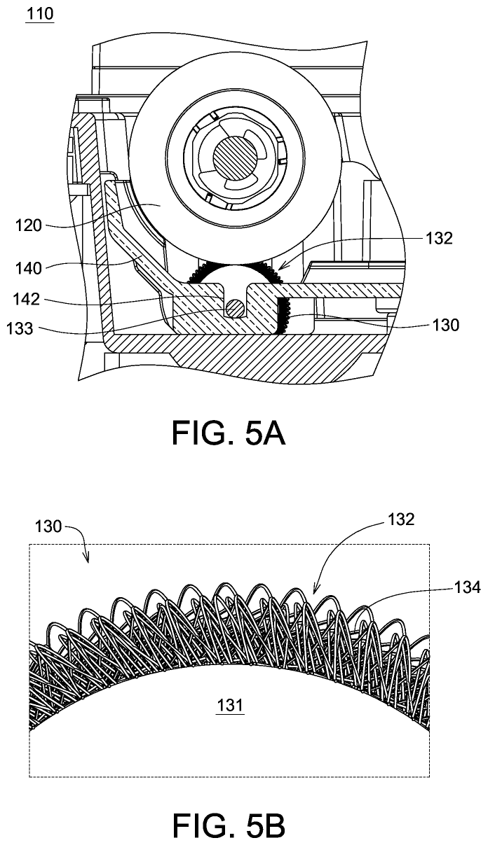

Refer to FIGS. 4, 5A and 5B. FIGS. 5A and 5B respectively are a schematic diagram of a cleaning member 130 and a partial enlargement of a friction surface 132 according to an embodiment of the present invention. The friction surface 132 of the cleaning member 130 tightly contacts the feed wheel 120. The cleaning member 130 can generate an upward elasticity force using an elasticity structure (such as a spring or an elastic piece). The upward elasticity force not only enables the friction surface 132 of the cleaning member 130 to contact the feed wheel 120 tightly, but also increases the frictional force to enhance the cleaning effect of the feed wheel 120. The paper transmitting device 110 may further include a tray 140 disposed under the feed wheel 120. The cleaning member 130 is fixed on the tray and contacts the surface of the feed wheel 120. When the feed wheel 120 rotates, the cleaning member 130 concurrently cleans the surface of the feed wheel 120. In another embodiment, the tray 140 has an accommodating slot 141 and two slot holes 142. The cleaning member 130 is disposed in the accommodating slot 141, and each of the two ends of the cleaning member 130 has a shaft 133 located in a corresponding slot hole 142. Therefore, the cleaning member 130 can be disposed under the feed wheel 120 through the tray 140 and can rotate around the shaft 133.

In FIGS. 5A and 5B, the cleaning member 130 has a wheel 131, which rotates around the shaft 133, the outer surface of the wheel 131 is covered with a fleece felt or a material with a fabric and porous structure for removing tiny medium off the surface of the feed wheel 120. The cleaning member 130 of the present embodiment is not limited to the wheel 131. The cleaning member 130 can be realized by any plate or cylinder with an arced surface covered with a woolen material as long as the plate or cylinder can be disposed in a space of the tray 140. The cleaning member 130 can contact the feed wheel 120 by an arced surface or a flat surface, and the present invention does not have specific restrictions regarding the said arrangement. Additionally, unlike the cleaning brush made of hair or nylon, which will be deformed when pressed and will generate elastic aging over a period of use, the cleaning member 130 of the embodiment has a fabric and porous structure 134, which is formed using a stamping process and has a high density, provides better pressure resistance, will not be deformed or generate elastic aging when pressed, is more durable, and does not damage the feed wheel 120. Moreover, the fibers on the surface of the cleaning member 130 of the present embodiment have a high density and provide a larger contact area to increase the cleaning effect of the feed wheel 120.

The paper transmitting device according to the above embodiments of the present invention can be used in an automatic document feeder, an office machine, a printer, a scanner, a facsimile machine, or a photocopier to avoid the fractional force being decreased due to an excessive amount of tiny medium alighting on the feed wheel and incapacitating paper feed. The cleaning member can be a fleece felt wheel, a horsehair wheel, a feather wheel, a cloth wheel, a leather wheel, a cotton wheel, a fleece polishing wheel, a nylon polishing wheel or a flat non-woven wheel. Based on the characteristics of the surface of the fleece felt wheel, a set of cleaning members is disposed at the vicinity of the original position of the feed wheel to remove paper crumbs off the surface of the feed wheel. In comparison to conventional hairbrush or cleaning brush, the fleece felt wheel of the present invention provides a better cleaning effect and a longer lifespan, does not damage damaging the feed wheel, and avoids paper crumbs filling the groove and incapacitating paper feed. Furthermore, the wearing of the fleece felt wheel also provides a cleaning effect, and the naturally formed pores can be used to receive paper crumbs and quickly remove them.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A paper transmitting device, comprising:
a feed wheel rotatably disposed for driving a document to move; and
a cleaning member disposed on one side of the feed wheel, wherein the cleaning member has a fabric and porous structure and a woolen friction surface with a pressure and wear resistance, so that the cleaning member tightly and fully contacts the feed wheel to clean the feed wheel without damaging the feed wheel.

2. The paper transmitting device according to claim 1, wherein the cleaning member is a woolen wheel or a plate or a cylinder with wool.

3. The paper transmitting device according to claim 2, wherein the cleaning member is a fleece felt wheel, a horsehair wheel or a feather wheel.

4. The paper transmitting device according to claim 1, wherein the cleaning member is a fleece polishing wheel.

5. The paper transmitting device according to claim 1, wherein the cleaning member has a high density surface which is formed using a stamping process and has a space for receiving tiny medium.

6. The paper transmitting device according to claim 1, wherein a surface of the feed wheel has at least one crumb discharge groove.

7. The paper transmitting device according to claim 1, further comprising a tray having an accommodating slot and two slot holes, wherein the cleaning member is disposed in the accommodating slot, and each of two ends of the cleaning member has a shaft located in a corresponding one of the slot holes.

8. The paper transmitting device according to claim 1, further comprising a driving wheel disposed on the other side of the feed wheel, wherein the feed wheel is located between the cleaning member and the driving wheel; the driving wheel and the feed wheel are used for holding and rotating the document to move.

9. An office machine, comprising:
a machinery body having a transmitting channel; and
a paper transmitting device according to claim 1, wherein the paper transmitting device is disposed in the machinery body.

10. A cleaning member used for cleaning a feed wheel, wherein the cleaning member has a fabric and porous structure and a woolen friction surface with a pressure and wear resistance, so that the cleaning member tightly and fully contacts the feed wheel to clean the feed wheel without damaging the feed wheel.
